(19) United States
(12) Patent Application Publication
(10) Pub. No.: US 2010/0044340 A1
(43) Pub. Date: Feb. 25, 2010

(54) METHOD OF FABRICATING MAGNETIC DEVICE

(75) Inventors: Yoshimitsu Kodaira, Tokyo (JP); Tomoaki Osada, Tokyo (JP)

Correspondence Address: FITZPATRICK CELLA HARPER & SCINTO, 1290 Avenue of the Americas, NEW YORK, NY, 10104-3800, US

(73) Assignee: CANON ANELVA CORPORATION, Kawasaki-shi (JP)

(21) Appl. No.: 12/556,987

(22) Filed: Sep. 10, 2009

Related U.S. Application Data
(63) Continuation of application No. PCT/JP2007/057689, filed on Mar. 30, 2007.

(51) Int. Cl. B44C 1/22

(52) U.S. Cl. 216/22

(57) ABSTRACT

A magnetic device is fabricated by etching a magnetic film in an atmosphere of plasma using a non-organic film as a mask. An atmosphere of plasma is generated by using at least one kind of gasifying compound selected from a gasifying compound group consisting of ethers, aldehydes, carboxylic acids, esters and diones; and by using a non-organic material mask, etching a magnetic film or diamagnetic film which includes at least one kind of metal selected from a metal group consisting of VIII group, IX group and X group elements in a periodic table. As a gas in the atmosphere of plasma, at least one kind of gas selected from a gas group consisting of oxygen, ozone, nitrogen, H₂O, N₂O, NO₂ and CO₂ can be added to the gasifying compound. The etching rate and the etching ratio were favorable.

### CROSS-REFERENCES TO RELATED APPLICATIONS

This application is a continuation application of International Application No. PCT/JP2007/057689, filed on Mar. 30, 2007, the entire contents of which are incorporated by reference herein.

### TECHNICAL FIELD

The present invention is related to a method of fabricating a magnetic device having a dry etching process. More specifically, the present invention is related to a method of fabricating a magnetic device having a process for performing dry etching at a high etching rate and a high selectivity when the micro-work of a magnetic thin film is carried out.

### RELATED ART

An MRAM (magnetic random access memory), which is an integrated magnetic memory, has attracted attention as a memory having an integration density similar to a DRAM and a high speed similar to an SRAM, and that can be limitlessly rewritten. Furthermore, a thin-film magnetic head, magnetic sensor and the like constituting magnetic resistance devices, such as GMR (gigantic magnetic resistance) and TMR (tunneling magnetic resistance), have been rapidly developed.

Heretofore, in the etching process of magnetic materials, ion milling has been frequently used. However, since ion milling is physical sputter etching, selectivity to various materials for the mask is difficult to obtain, and problems wherein the bottom of the material to be etched was tapered have been caused. Therefore, it is the present situation that ion milling is not suited for the fabrication of large-capacity MRAM, which requires especially fine processing techniques, that it is difficult to uniformly process large-area 300 mm substrates, and that the yield cannot be raised.

In place of such ion milling, techniques cultivated in the semiconductor industry have been introduced.

Among these, RIE (Reactive Ion Etching) technology, which can secure uniformity in large-area 300 mm substrates, and excels in micro-work characteristics, is anticipated.

However, even with the RIE technology widely used in the semiconductor industry, the reactivity to magnetic materials, such as FeNi, CoFe and CoPt was poor, and it was difficult to process them without producing etching residues and sidewall depositions.

As methods for fabricating magnetic devices using a process for the dry etching of magnetic films, for the selective etching of a magnetic material of transition elements, Japanese Patent Application Laid-Open No. H8-253881 proposes carbon monoxide (CO) gas to which a nitrogen-containing compound gas, such as ammonia (NH₃) and amine gas, is added, as the reaction gas for dry etching; Japanese Patent Application Laid-Open No. 2005-42143 proposes alcohols having at least one hydroxyl group as the etching gas for dry etching of a magnetic material using a non-organic material as a mask; and Japanese Patent Application Laid-Open No. 2005-268349 proposes a gas containing at least methane and oxygen as the dry etching gas for the magnetic material of difficult-to-etch elements, such as Pt and Ir.

### SUMMARY OF THE INVENTION

An object of the present invention is to provide a dry etching process on the basis of high-rate etching and high selectivity, wherein no after-corrosion treatment or no corrosion resistant treatment is required when a mask material (non-organic material mask) formed of a non-organic material, such as a metal atom material selected from a metal group consisting of III group, IV group, V group and VI group in a periodic table, or a material formed of these metal atoms and non-metal atoms is used.

Another object of the present invention is to provide a method of fabricating a magnetic device using the above-described dry etching process.

To achieve the above-described objects, the present invention is, firstly a method of fabricating a magnetic device characterized by including the steps of etching a magnetic film or diamagnetic film which includes at least one kind of metal selected from a metal group consisting of VIII group, IX group and X group elements in a periodic table by using a non-organic material mask, in an atmosphere of plasma generated by using at least one kind of compound selected from a gasifying compound group consisting of ethers, aldehydes, carboxylic acids, esters, diones and amines; and secondly a method of fabricating a magnetic device characterized by including the steps of etching a magnetic film or diamagnetic film which includes at least one kind of metal selected from a metal group consisting of VIII group, IX group and X group element in a periodic table by using a non-organic material mask, in an atmosphere of plasma generated by using at least one kind of compound selected from a gasifying compound group consisting of ethers, aldehydes, carboxylic acids, esters, diones and amines, and at least one kind of gas selected from a gas group consisting of oxygen, ozone, nitrogen, H₂O, N₂O, NO₂ and CO₂.

In the fabricating method of the present invention, as the ethers, at least one kind of ether selected from a compound group consisting of dimethyl ether, diethyl ether and ethylene oxide can be cited.

In the fabricating method of the present invention, as the aldehydes, at least one kind of aldehyde selected from a compound group consisting of formaldehyde and acetaldehyde can be cited.

In the fabricating method of the present invention, as the carbonic acids, at least one kind of carboxylic acid selected from a compound group consisting of formic acid and acetic acid can be cited.

In the fabricating method of the present invention, as the esters, at least one kind of ester selected from a compound group consisting of ethyl chloroformate and ethyl acetate can be cited.

In the fabricating method of the present invention, as the amines, at least one kind of amine selected from a compound group consisting of dimethylamine and triethylamine can be cited.

In the fabricating method of the present invention, as the diones, at least one kind of dione selected from a compound group consisting of tetramethylheptadione, acetylacetone and hexafluoroacetylacetone can be cited.

The mask material (non-organic material mask) used in the present invention is a non-organic material composed of a single-layer film or a laminated film formed of a substance produced by mixing a metal atom material selected from a metal group consisting of III group, IV group, V group and VI group in a periodic table, for example, Ta, Ti Al or Si, or a mixed material of such metal atoms and non-metal atoms, for example, a non-organic mask material composed of a single-layer film or a laminated film formed of a metal such as Ta, Ti and Al or a non-metal such as Si, or the oxide or nitride of these metals or non-metals, can be used.

As the non-organic material mask used in the present invention, for example, a single-layer film or a laminated film of simple elements Ta, Ti, Al or Si can be used as the mask material. Alternatively, a single-layer film or a laminated film of oxides or nitrides of Ta, Ti, Al or Si such as, Ta oxides, Ti oxides, Al oxides such as Al₂O₃, Si oxides such as SiO₂, and TaN, TiN, AlN, SiN or the like can be used as the mask material. When the above-described single-layer film is used, the thickness thereof is 2 to 300 nm, preferably 15 to 30 nm. When the above-described laminated film is used, the laminated thickness thereof is 2 to 300 nm, preferably 15 to 30 nm.

In the fabricating method according to the present invention, as a magnetic film or a diamagnetic film composed of at least one kind of metal selected from a metal group consisting of VIII group, IX group and X group in a periodic table to be subjected to etching process, an FeN film, NiFe film, CoFe film, CoFeB film, PtMn film, IrMn film, CoCr film, CoCrPt film, NiFeCo film, NiFeMo film, CoFeB film, FeMn film, CoPt film, NiFeCr film, CoCr film, CoPd film, CoFeB film or NiFeTb film can be used. These magnetic films or diamagnetic films may be ferromagnetic or soft magnetic. Although the content of magnetic substance contained in these magnetic films or diamagnetic films is 10 atomic % or more, preferably 50 atomic % or more, it is not limited to these values.

In the fabricating method according to the present invention, the magnetic film or diamagnetic film to be subjected to the etching process may be a single-layer film or a laminated film. When the single-layer film is used, the thickness thereof is 2 to 300 nm, preferably 15 to 30 nm. When the laminated film is used, the laminated thickness thereof is 2 to 300 nm, preferably 15 to 30 nm.

In the fabricating method according to the present invention, the etching temperature when etching a magnetic film or diamagnetic film is preferably maintained within a range of 250° C. or lower. If the temperature exceeds 250° C., undesired thermal damage is given to the magnetic film. The preferable temperature range of the present invention is 20 to 100° C.

Also in the fabricating method according to the present invention, the vacuum during etching is preferably a range between 0.05 and 10 Pa. Within this pressure range, the magnetic device can be anisotropically processed by the formation of high-density plasma.

In the fabricating method according to the present invention, an oxidation gas or a nitriding gas (adding gas), such as oxygen, ozone, nitrogen, H₂O, N₂O, NO₂ CO₂ can be added to the above-described gasified compound within a range not exceeding 50 atomic %.

Also in the present invention, it is preferable to add an inert gas to the above-described gasified compound within a range not exceeding 90 atomic %. As the inert gas, Ar, Ne, Xe, Kr or the like can be used. At this time, a mixed gas of the above-described adding gas and an inert gas may also be used. Also at this time, it is preferable that the quantity of the mixed gas is within the range of the above-described quantity.

According to the fabricating method of the present invention, if the above-described adding gas or inert gas is added to the above-described gasifying compounds within the above-described range, the etching rate can be further increased, and at the same time, the selectivity to the mask can be significantly enhanced. However, if more than 50 atomic % of the adding gas is used, decrease in the etching rate will occur, and the lowering of selectivity for the non-organic material mask will also be caused.

In the dry etching method used in the fabricating method of the present invention, when the magnetic material is etched using the mask material composed of non-organic material, no after-corrosion treatment is required, and the consideration of corrosion resistance to the etching apparatus is unnecessary. According to the present invention, as described above, a high etching rate and a large selectivity could be achieved, and by the high etching rate and large selectivity, a high degree of micro-work of a magnetic thin film composed of a single-layer film or a laminated film can be realized. Thereby, the yield of highly integrated MRAM could be significantly improved.

### BRIEF DESCRIPTION OF THE DRAWINGS

FIG. 1A is a schematic configuration diagram of an etching apparatus used in the method in an example of the present invention;

FIG. 1B is a top view of the apparatus shown in FIG. 1A;

FIG. 2A is a schematic sectional view of a wafer (magnetic layer laminated substrate) before the start processing;

FIG. 2B is a schematic sectional view when a Ta mask has been fabricated on the wafer shown in FIG. 2A;

FIG. 2C is a schematic sectional view showing an example of a magnetic film in a TMR fabricated by etching using the Ta mask shown in FIG. 2B;

FIG. 3 is a schematic sectional view showing another example of a magnetic film in a TMR according to the present invention;

FIG. 4 is a vertical sectional view showing a basic structure of a TMR section fabricated in the present invention; and

FIG. 5 is diagrams illustrating change in resistance values in the TMR section fabricated in the present invention.

### DETAILED DESCRIPTION OF EMBODIMENT

### Example 1

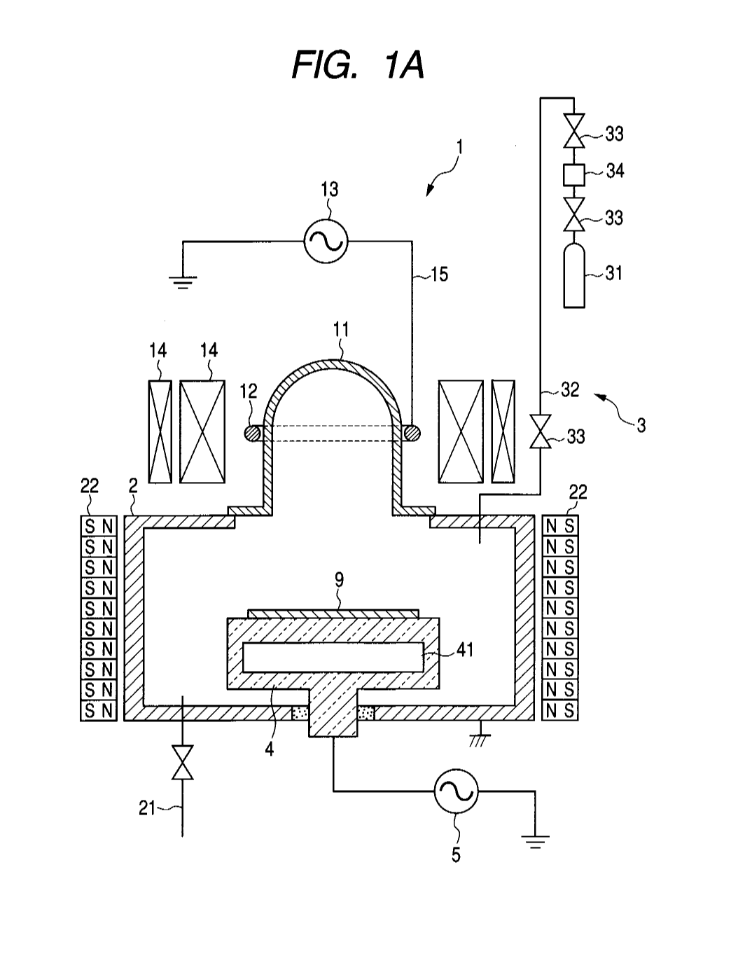

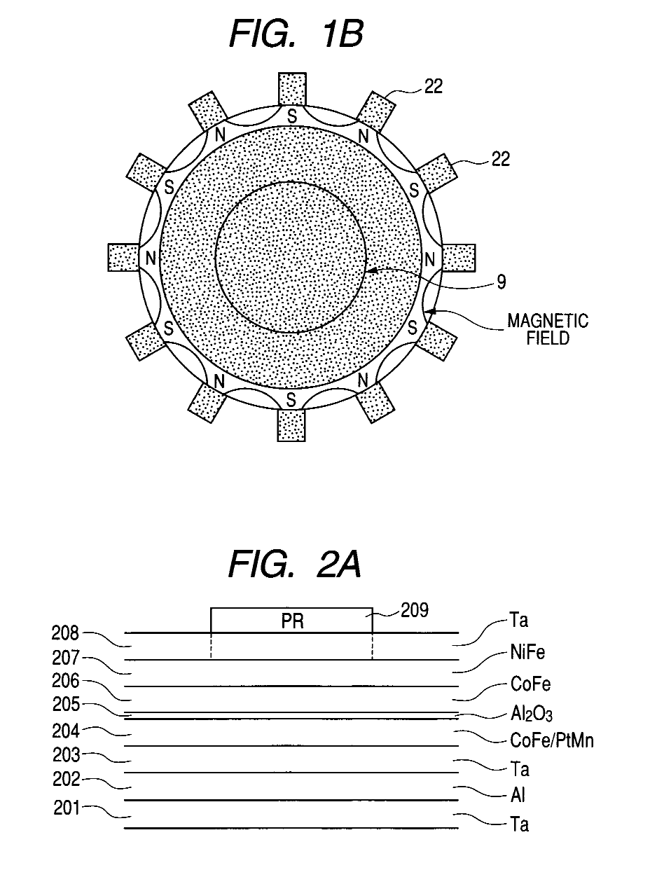

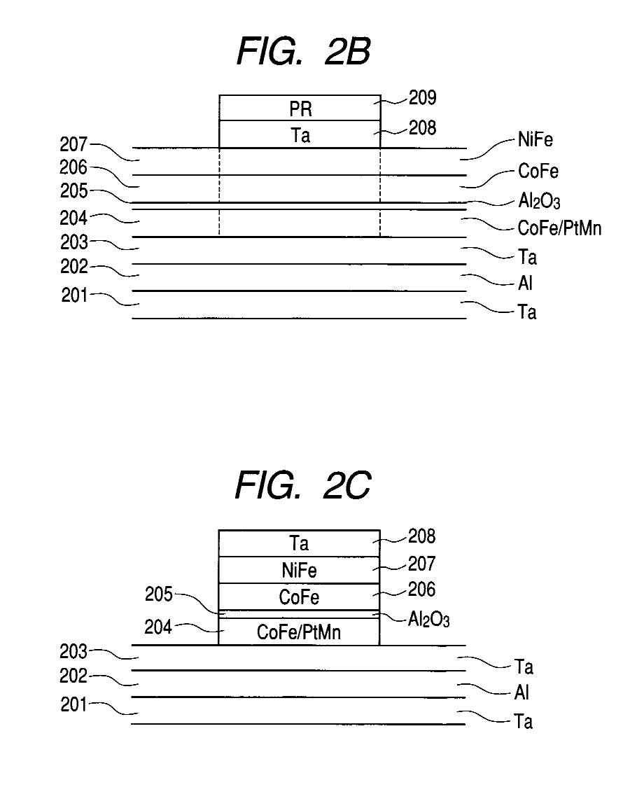

FIG. 1 is a schematic diagram of an etching apparatus having an ICP (inductive Coupled Plasma) plasma source. In Example 1, acetic acid is used as a gasifying compound, a mixed gas of the acetic acid and oxygen gas is used as an etching gas, and by using an apparatus shown in FIG. 1, a TMR element is etched as shown in FIG. 2A and FIG. 2B. FIG. 2C and FIG. 3 show two examples of TMR fabricated using a fabricating method according to the present invention. FIG. 2A shows a laminated structure before the etching process used in the present invention. This is a wafer 9 shown in FIG. 1A, wherein magnetic material layers and the like are laminated on a substrate composed of quartz or the like, and is the object of etching.

In FIG. 2A, 201 denotes a Ta film, 202 denotes an Al film, 203 denotes a Ta film, 204 denote a laminated ferromagnetic film to be a pin layer composed of a soft magnetic CoFe film having a thickness of 1 nm to 2.0 nm (preferably 5 nm) and a PtMn film, which is an anti-ferromagnetic film, 205 denotes an insulating film formed of Al₂O₃ (having a thickness of 0.1 nm to 10 nm, preferably 0.5 nm to 2 nm), 206 denotes a soft magnetic film to be a free layer formed of a CoFe film having a thickness of 1 nm to 20 nm (preferably 5 nm), 207 is a soft magnetic film formed of a NiFe film, 208 denotes a mask formed of Ta, and 209 denotes a patterned photoresist film.

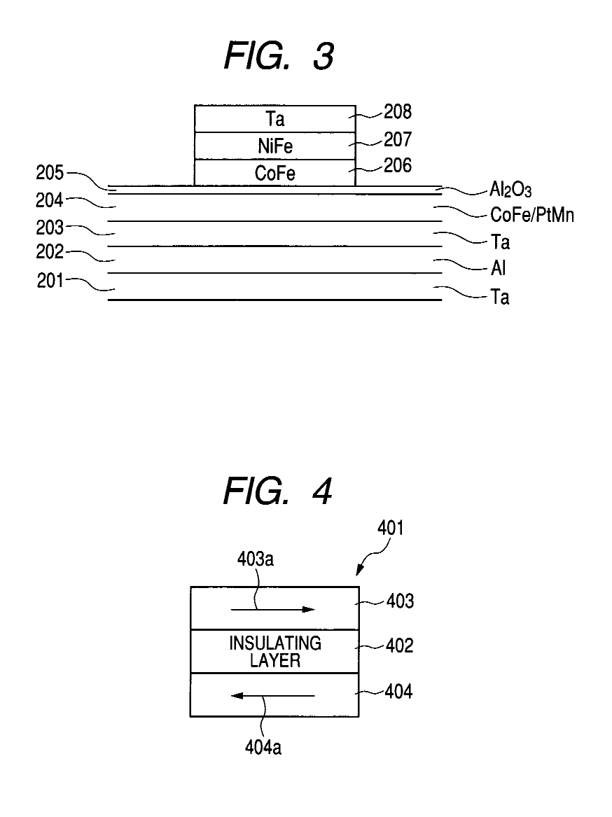

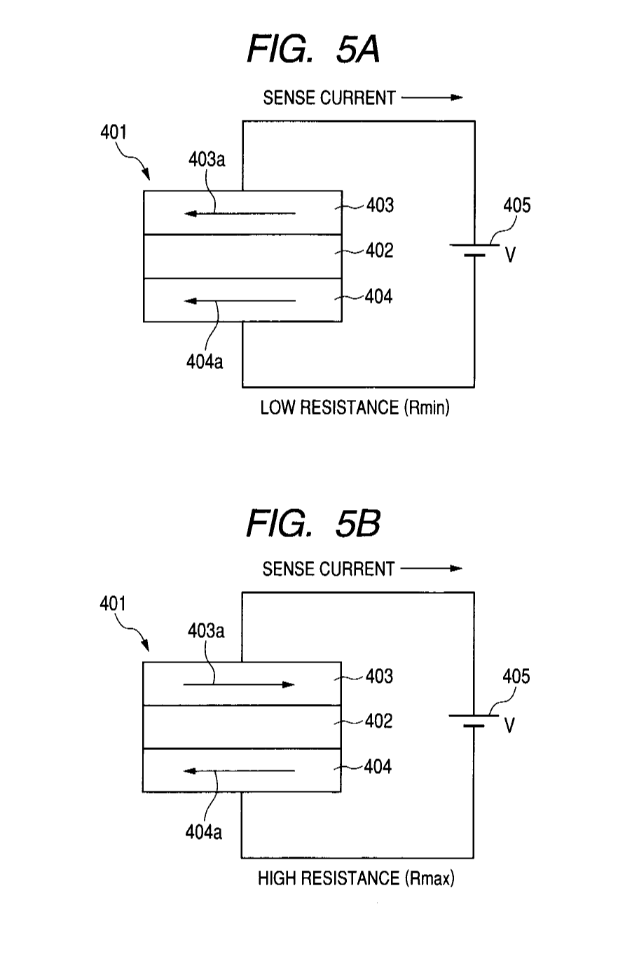

The fundamental structure of a TMR element fabricated by the fabricating method according to the present invention will be shown in FIG. 4. The fundamental structure of TMR 401 is a structure wherein the both sides of insulating layer 402 (corresponding to Al₂O₃ insulating film 205 in FIG. 2) are sandwiched between ferromagnetic layer 403 (corresponding to the laminated film of NiFe film 207 and CoFe film 206 in FIG. 2) and 404 (corresponding to CoFe/PtMn film 204 in FIG. 2). In ferromagnetic layers 403 and 404, arrows 403a and 404a show the direction of magnetization, respectively. FIG. 5A and FIG. 5B are diagrams illustrating the resistance states in TMR 401 when a voltage V is applied to the TMR 401 from power source 405. The TMR 401 has characteristics to change resistance values depending on the applied voltage V, corresponding to the state of magnetization in each of ferromagnetic layer 403 and 404. Specifically, as shown in FIG. 5A, when the direction of magnetization in the ferromagnetic layer 403 and 404 is the same, the resistance value of the TMR 401 is minimized; and as shown in FIG. 5B, when the direction of magnetization in the ferromagnetic layer 403 and 404 is opposite to each other, the resistance value of the TMR 401 is maximized. The minimum resistance value and the maximum resistance value of the TMR 401 are represented by Rmin and Rmax, respectively. Here, in general, although there are a structure of the CIP (Current-in-Plane) type, wherein the sensing current is introduced in parallel to the film surface of the device; and a structure of the CPP (Current Perpendicular to Plane) type, wherein the sensing current is introduced in perpendicular to the film surface of the device, FIG. 4 and FIG. 5 show an example of a magnetic resistance effect element of the CPP type.

FIG. 2B shows the state after etching a Ta film using the patterned photoresist film 209 shown in FIG. 1 and CF₄ gas, which is an etching gas. In the etching process of Ta film 208, an apparatus shown in FIG. 1 was used. The vacuum vessel 2 shown in FIG. 1A was evacuated using exhaustion system 21, a gate valve (not shown) was opened to introduce a wafer 9 provided with the laminated magnetic film shown in FIG. 2A into the vacuum vessel 2, the wafer 9 was held in the substrate holder 4, and maintained at a predetermined temperature using temperature control mechanism 41. Next, the gas-introducing system 3 is operated to introduce a predetermined flow rate of etching gas (CF₄) from a cylinder that stores CF₄ gas not shown in FIG. 1A, through pipes, a valve and a flow rate controller (not shown), into the vacuum vessel 2. The introduced etching gas is diffused in dielectric-wall vessel 11 through the vacuum vessel 2. Here, plasma source apparatus 1 is operated. The plasma source apparatus 1 is composed of the air-tightly connected dielectric-wall vessel 11, 1-turn antenna 12 that generates an inductive magnetic field in the dielectric-wall vessel 11, high-frequency power source for plasma 13 connected to the antenna 12 by transmission channel 15 through a matching box (not shown) that generates a high-frequency power (source power) to be supplied to the antenna 12, electromagnet 14 that generates a predetermined magnetic field in the dielectric-wall vessel 11, and the like, so that the internal space is communicated with the vacuum vessel 2. When high-frequency waves generated by the high-frequency power source for plasma 13 are supplied to the antenna 12 by transmission channel 15, current flows in the 1-turn antenna 12, and as a result, plasma is formed inside the dielectric-wall vessel 11.

The structure of the apparatus viewed from the top is shown in FIG. 1B. A large number of magnets for sidewalls 22 are disposed on the outside of the sidewalls of the vacuum vessel 2, arrayed in the peripheral direction so that the magnetic polarities thereof on the surface facing the sidewall of the vacuum vessel 2 are different from the adjacent magnets, thereby, cusped magnetic fields are sequentially formed in a circumferential direction along the inner surface of the sidewalls of the vacuum vessel 2, and the diffusion of plasma into the inner surface of the sidewalls of the vacuum vessel 2. At this time, the high-frequency power source for bias 5 is simultaneously operated so as to supply self-bias voltage, which is the voltage for the negative direct current to the wafer 9 to be subjected to etching treatment, and to control the ion-implanting energy from the plasma to the surface of the wafer 9. The plasma formed as described above diffuses into the vacuum vessel 2 from the dielectric-wall vessel 11, and reaches to the vicinity of the surface of the wafer 9. At this time, the Ta film not coated with the photoresist (PR) film 209 is exposed to the plasma, etched by the etching gas CF₄, and the Ta mask 208 is formed from the Ta film on the wafer 9 as shown in FIG. 2B.

The etching conditions for the Ta film by the above-described CF₄ using the photoresist film 209 as a mask were as follows:

### <Etching Conditions>

Flow rate of etching gas (CF₄): 326 mg/min (50 sccm)
Source power: 500 W
Bias power: 70 W
Pressure in vacuum vessel 2: 0.8 Pa
Temperature of substrate holder 4: 40° C.

Next, after removing photoresist 209, an etching process wherein acetic acid gas and oxygen gas were used as etching gases, and Ta formed by the above-described process is used as a masking material for etching NiFe film 207, CoFe film 206, Al₂O₃ film 205 and CoFeB/PtMn film 204, was carried out to fabricate a magnetic film shown in FIG. 2C. In the above-described process, the apparatus shown in FIG. 1 was also used except that CF4 gas was used in place of the mixed gas consisting of acetic acid gas and oxygen gas. The etching conditions at this time were as described below. The etching rate (nm/min) at this time was measured using a routine procedure. The result was 30 nm/min. Also using a routine procedure, the selectivity ratio of the laminated film of films 204 to 207 to the Ta film 203 (etching rate of laminated films 204 to 207/etching rate of the Ta film 203) was measured. The result was 10 times.

### <Etching Conditions>

Flow rate of acetic acid: 15 sccm (40.2 mg/min)
Flow rate of oxygen: 5 sccm (7.1 mg/min)
Source power: 1000 W
Bias power: 800 W
Pressure in vacuum vessel 2: 0.4 Pa
Temperature of substrate holder 4: 40° C.

At this time, by operating the gas-introducing system 3, from a vessel 31 wherein acetic acid was stored shown in FIG. 1A, a predetermined flow rate of the etching gas (acetic acid) and oxygen gas were introduced into the vacuum vessel 2 through pipes 32, a valve 33 and a flow rate controller 34, into the vacuum vessel 2, and etching was carried out. After etching in this process, the structure shown in FIG. 2C was confirmed.

### Examples 2 to 20 and Comparative Example 1

An element shown in FIG. 2C was formed in the same manner as in Example 1, except that the etching gas shown in Table 2 in place of the etching gas consisting of acetic acid gas and oxygen gas used in the above-described Example 1, and the etching rate and the selectivity were measured. The results are shown in Table 1 below. The etching rates shown in Table 1 are shown as the ratios when the etching rate in Example 1 is “1”, and the selectivity is “1”.

TABLE 1

| Example | Etching gas (flow rate) | Etching rate | Selectivity |
|---|---|---|---|
| 2 | Dimethyl ether (15 sccm, 30.9 mg/min.) | 1.1 | 0.8 |
| 3 | Dimethyl ether (15 sccm, 30.9 mg/min.) and | 1.1 | 1.2 |
| | oxygen (5 sccm, 7.1 mg/min.) | | |
| 4 | Ethylene oxide (15 sccm, 29.6 mg/min.) and | 1.0 | 0.9 |
| | oxygen (5 sccm, 7.1) mg/min.) | | |
| 5 | Formaldehyde (15 sccm, 20.1 mg/min.) | 0.9 | 0.9 |
| 6 | Formaldehyde (15 sccm, 20.1 mg/min.) and | 1.0 | 1.1 |
| | oxygen (5 sccm, 7.1 mg/min.) | | |
| 7 | Formaldehyde (15 sccm, 20.1 mg/min.), | 1.2 | 0.9 |
| | oxygen (20 sccm, 35.7 mg/min.) and | | |
| | argon (5 sccm, 7.1 mg/min.) | | |
| 8 | Acetic acid (15 sccm, 40.2 mg/min.) | 0.8 | 0.9 |
| 9 | Acetic acid (15 sccm, 40.2 mg/min.), | 1.3 | 0.9 |
| | oxygen (5 sccm, 7.1 mg/min.) and | | |
| | argon (20 sccm, 35.7 mg/min.) | | |
| 10 | Ethyl acetate (15 sccm, 59.0 mg/min.), | 1.1 | 0.9 |
| | oxygen (5 sccm, 7.1 mg/min.) and | | |
| | argon (20 sccm, 35.7 mg/min.) | | |
| 11 | Dimethyl amine (15 sccm, 67.1 mg/min.) and | 1.2 | 0.8 |
| | oxygen (5 sccm, 7.1 mg/min.) | | |
| 12 | Dimethyl amine (15 sccm, 67.1 mg/min.), | 1.2 | 0.8 |
| | oxygen (1 sccm, 1.4 mg/min.) and | | |
| | argon (20 sccm, 35.7 mg/min.) | | |
| 13 | Acetyl acetone (15 sccm, 67.0 mg/min.) and | 1.1 | 0.8 |
| | oxygen (5 sccm, 7.1 mg/min.) | | |
| 14 | Acetyl acetone (15 sccm, 67.0 mg/min.), | 1.1 | 0.6 |
| | oxygen (5 sccm 7.1 mg/min.) and | | |
| | argon (20 sccm, 35.7 mg/min.) | | |
| 15 | Dimethyl ether (15 sccm, 30.9 mg/min.), | 1.1 | 0.9 |
| | NO₂ (5 sccm, 10.3 mg/min.) and | | |
| | argon (20 sccm, 35.7 mg/min.) | | |
| 16 | Dimethyl ether (15 sccm, 30.9 mg/min.), | 1.2 | 0.7 |
| | N₂ (5 sccm, 6.3 mg/min.) and | | |
| | argon (20 sccm, 35.7 mg/min.) | | |
| 17 | Dimethyl ether (15 sccm, 30.9 mg/min.), | 1.2 | 0.8 |
| | H₂O (5 sccm, 4.0 mg/min.) and | | |
| | argon (20 sccm, 35.7 mg/min.) | | |
| 18 | Dimethyl ether (15 sccm, 30.9 mg/min.), | 1.1 | 0.7 |
| | CO₂ (5 sccm, 9.8 mg/min.) and | | |
| | argon (20 sccm, 35.7 mg/min.) | | |
| 19 | Dimethyl ether (15 sccm, 30.9 mg/min.), | 1.3 | 0.8 |
| | ozone (3 sccm, 6.4 mg/min.) and | | |
| | argon (25 sccm, 44.6 mg/min.) | | |
| 20 | Acetic acid (15 sccm, 40.2 mg/min.), | 1.3 | 0.9 |
| | ozone (3 sccm, 6.4 mg/min.) and | | |
| | argon (25 sccm, 44.6 mg/min.) | | |
| Comparative | Methane (15 sccm, 10.8 mg/min.), and | 0.3 | 0.8 |
| Example 1 | oxygen (5 sccm, 7.1 mg/min.) | | |

As described above, the dry etching method used in the fabricating method according to the present invention exhibited an unexpectedly significant effect.

### Examples 21 to 25 and Comparative Example 2

An element shown in FIG. 2C was formed in the same manner as in Example 1, 9, 3, 6 and 13 except that the flow rates of the etching gas in the above-described Examples were changed, and the etching rates and the selectivity were measured. The results are shown in Table 2. The etching rates shown in Table 2 are shown as the ratios when the etching rate in Example 1 is “1”, and the selectivity is “1”.

TABLE 2

| Example | Etching gas (flow rate) | Etching rate | Selectivity |
|---|---|---|---|
| 21 | Acetic acid (20 sccm, 53.6 mg/min.) and | 0.8 | 0.8 |
| | oxygen (10 sccm, 14.2 mg/min.) | | |
| 22 | Acetic acid (20 sccm, 53.6 mg/min.), | 0.7 | 0.9 |
| | oxygen (10 sccm, 14.2 mg/min.) and | | |
| | argon (30 sccm, 53.5 mg/min.) | | |
| 23 | Dimethyl ether (20 sccm, 41.2 mg/min.) and | 0.8 | 1.1 |
| | oxygen (10 sccm, 14.2 mg/min.) | | |
| 24 | Formaldehyde (20 sccm, 26.8 mg/min.) and | 0.8 | 1.1 |
| | oxygen (10 sccm, 14.2 mg/min.) | | |
| 25 | Acetyl acetone (20 sccm, 89.3 mg/min.) and | 0.7 | 1.1 |
| | oxygen (10 sccm, 14.2 mg/min.) | | |
| Comparative | Methane (20 sccm, 14.4 mg/min.), and | 0.5 | 0.7 |
| Example 2 | oxygen (10 sccm, 14.2 mg/min.) | | |

Among ethers, aldehydes, carboxylic acids, diones and amines, ethers and aldehydes are not corrosive, and especially advantageous in safety.

Although a certain number of examples and comparative test examples of the present invention have been described, the present invention is not limited to the described embodiments, but can be changed to various embodiments within a technical range grasped from the description of claims. For example, the etching apparatus is not limited to the ICP-type plasma apparatus having a 1-turn antenna shown in FIG. 1, but a helicon-type plasma apparatus, a two-frequency excitation parallel plate-type plasma apparatus, a microwave-type plasma apparatus or the like, referred to as a high-density plasma source, can be used. In addition, even in the case of etching a magnetic material using a non-organic material as a mask material, and in the case wherein the magnetic material is a TMR, the configuration of the TMR is not limited to the configuration shown in FIG. 2. Furthermore, the present invention is not limited to the above-described TMR, but can be applied to the GMR. Moreover, as shown in FIG. 3, the process wherein the insulating film 205 is used as the etching stopper shown in FIG. 2A can be used.

1. A method of fabricating a magnetic device comprising the steps of:
forming an atmosphere of plasma generated by using one kind or at least two kinds of compound selected from a gasifying compound group consisting of ethers, aldehydes, carboxylic acids, esters, diones and amines and
by using a non-organic material mask, etching a magnetic film or diamagnetic film which includes at least one kind of metal selected from a metal group consisting of Fe, Co and Ni.

2. The method of fabricating a magnetic device according to claim 1, wherein said ethers are at least one kind of ether selected from a compound group consisting of dimethyl ether and ethylene oxide.

3. The method of fabricating a magnetic device according to claim 1, wherein said aldehydes is formaldehyde.

4. The method of fabricating a magnetic device according to claim 1, wherein said carboxylic acids is acetic acid.

5. The method of fabricating a magnetic device according to claim 1, wherein said esters is ethyl acetate.

6. The method of fabricating a magnetic device according to claim 1, wherein said amines is dimethylamine.

7. The method of fabricating a magnetic device according to claim 1, wherein said diones are at least one kind of dione selected from a compound group consisting of acetyl acetone and hexafluoro acetyl acetone.

8. The method of fabricating a magnetic device according to claim 1, wherein said magnetic device is a TMR element.

9. The method of fabricating a magnetic device according to claim 1, wherein said atmosphere of plasma is formed by adding at least one kind of gas selected from a gas group consisting of oxygen, ozone, nitrogen, H₂O, NO₂ and CO₂ to said gasifying compound.

10. The method of fabricating a magnetic device according to claim 9, wherein said ethers are at least one kind of ether selected from a compound group consisting of dimethyl ether and ethylene oxide.

11. The method of fabricating a magnetic device according to claim 9, wherein said aldehydes is formaldehyde.

12. The method of fabricating a magnetic device according to claim 9, wherein said carboxylic acids is acetic acid.

13. The method of fabricating a magnetic device according to claim 9, wherein said esters is ethyl acetate.

14. The method of fabricating a magnetic device according to claim 9, wherein said amines is dimethylamine.

15. The method of fabricating a magnetic device according to claim 9, wherein said diones are at least one kind of dione selected from a compound group consisting of acetylacetone and hexafluoroacetylacetone.

16. The method of fabricating a magnetic device according to claim 1, wherein said non-organic material mask includes at least one film of a metal atom material selected from a metal group consisting of III group, IV group, V group and VI group in a periodic table, or a mixed material of such metal atoms and non-metal atoms.

17. The method of fabricating a magnetic device according to claim 16, wherein said non-organic material mask includes at least one film composed of Ta or Ti metal, a non-metal, an oxide of such metals or non-metals, or a nitride of such metals of non-metals.

18. The method of fabricating a magnetic device according to claim 17, wherein said non-metal is Si.

19. The method of fabricating a magnetic device according to claim 1, wherein said magnetic film is a laminated magnetic films and diamagnetic films.

20. The method of fabricating a magnetic device according to claim 1, wherein said magnetic device is a TMR.
